(19) United States
(12) Patent Application Publication
(10) Pub. No.: US 2025/0291272 A1
(43) Pub. Date: Sep. 18, 2025

(54) IMAGE FORMING DEVICE

(71) Applicant: SHARP KABUSHIKI KAISHA, Osaka (JP)

(72) Inventor: SHOHEI FUKUMOTO, Osaka (JP)

(21) Appl. No.: 19/073,375

(22) Filed: Mar. 7, 2025

(30) Foreign Application Priority Data
Mar. 12, 2024 (JP) 2024-038344

(51) Int. Cl. G03G 15/08; G03G 15/00

(52) U.S. Cl. CPC G03G 15/0812; G03G 15/0863; G03G 15/0865; G03G 15/5058; G03G 2215/00059; G03G 2215/00063

(57) ABSTRACT

An image forming device includes: a photoreceptor drum; a developer that forms a toner image on the photoreceptor drum; a development-power supplier that supplies the developer with a developing bias; an image sensor that detects a density of a toner image; an environment sensor that detects a temperature and humidity; a replenisher that replenishes the developer with toner; and a controller that causes image-quality adjustment that changes the developing bias to be performed. The controller includes a storage that holds a replenishment condition in which timing at which the replenisher replenishes the toner is set, a correction value for the replenishment condition, and an ideal bias, and the controller corrects a correction value used until the next image-quality adjustment based on a bias difference that is a difference between an adjustment bias and the ideal bias, and a last correction value set in the last image-quality adjustment.

### FIELD OF THE INVENTION

The present disclosure relates to an image forming device that forms a toner image on an image carrier.

### BACKGROUND ART

In a known electrophotographic-type image forming device, a toner image formed on a photoreceptor is transferred to a sheet to perform image formation. In recent years, since the toner is consumed when image formation is repeated, the device employs a method of replacing a cartridge (container) that accommodates the toner. In a case of the image forming device employing this method, a developing means accommodates a developing agent. When the developing agent in the developing means is consumed due to image formation, the developing means is replenished with the developing agent from the cartridge on an as-necessary basis.

In addition, in a case of an image forming device that forms a color image, a plurality of photoreceptors are provided to form a plurality of colors of toner image. In order to form a desired color image, there is proposed a method of controlling a developing bias supplied to the developing means formed at a photoreceptor corresponding to each color of the toner image and the toner density of a developing agent in each of the developing means.

### SUMMARY

### Means to Solve the Problem

The above-described known image forming device that forms a color image is configured such that the surface of the photoreceptor charged by a charging means is exposed by an exposure means to form an electrostatic latent image based on an image signal, on the surface of the photoreceptor. Next, the image forming device is configured such that a voltage of developing bias is applied to a two-component developing agent including toner and a carrier and accommodated in the developing means to develop an electrostatic latent image formed on the
surface of the photoreceptor, thereby forming a toner image on the surface of the photoreceptor. The image forming device transfers the toner image formed on the surface of the photoreceptor to an intermediate transfer belt, whereby the toner image that has been transferred to the intermediate transfer belt is transferred on a recording material by a transfer means. The toner image transferred on the recording material is fixed on the recording material by a fixing means. In addition, the image forming device includes a plurality of photoreceptors and development means as described above. The image forming device includes: a toner-attachment-amount detecting sensor that detects the toner-attachment amount corresponding to the amount of toner on the toner image (patch image) formed on each of the photoreceptors and transferred to the intermediate transfer belt; a toner-density detecting sensor that detects the toner density in the developing agent within each of the developing means; and a control means that controls the voltage of developing bias supplied to each of the developing means and the toner density within each of the developing means. Furthermore, the control means sets a common voltage of developing bias supplied to all the developing means based on the voltage of developing bias from which the target amount of attachment of toner can be obtained, and controls the individual control target value of the toner density for each of the developing means.

In a case of the known image forming device, the toner-density detecting sensor is provided to individually control the toner density within each of the developing means, and the individual control target value of the toner density is set for each of the developing means to form a desired color image. However, in a case of a configuration in which the toner-density detecting sensor is not provided, it is not possible to detect the toner density within the developing means, which results in a problem in which it is difficult to form a desired color image. In addition, in a case where the toner-density detecting sensor is provided, the number of components increases. This results in a problem in which the cost increases.

The present disclosure is provided to solve the problems described above, and an object of the present disclosure is to provide an image forming device that supplies toner at appropriate timing, which makes it possible to form a desired color image without providing any toner-density detecting sensor that detects a toner density within the developing means.

### Solution to Problem

An image forming device according to the present disclosure includes: an image carrier including a surface charged at a predetermined potential; a developer that forms a toner image on the image carrier; a development-power supplier that supplies the developer with a developing bias; an image sensor that detects a density of a toner image formed by the developer; an environment sensor that detects a temperature and humidity; a replenisher that replenishes the developer with toner; and a controller that causes image-quality adjustment that changes the developing bias to be performed based on a result of detection of the image sensor, in which the controller includes a storage that holds a replenishment condition, a correction value for the replenishment condition set in the image-quality adjustment, and an ideal bias set based on a result of detection of the environment sensor, the replenishment condition being a condition in which timing at which the replenisher replenishes the toner is set, and the controller corrects a correction value used until next image-quality adjustment based on a bias difference between the ideal bias and an adjustment bias calculated at a time of the image-quality adjustment, and a last correction value set in image-quality adjustment at last time.

The image forming device according to the present disclosure may be configured such that the storage holds a correction table in which a reflection rate corresponding to the bias difference is set, and at a time of the image-quality adjustment, the controller corrects the correction value by looking up the reflection rate in the correction table.

The image forming device according to the present disclosure may be configured such that the controller changes an interval for next image-quality adjustment based on the bias difference.

The image forming device according to the present disclosure may be configured such that the image carrier includes a plurality of photoreceptor drums and an intermediate transfer belt to which a toner image on each of the plurality of photoreceptor drums is transferred, and a plurality of the developers and the replenishers are provided so as to correspond to the plurality of photoreceptor drums.

The image forming device according to the present disclosure may be configured such that during the image-quality adjustment, the bias difference is calculated for each of the plurality of the developers, and the controller changes an interval for next image-quality adjustment based on the bias difference having a maximum value.

The image forming device according to the present disclosure may be configured such that the development-power supplier supplies a common bias that is common to the plurality of the developers as the developing bias, and the controller corrects the correction value based on a difference between the common bias and the adjustment bias.

The image forming device according to the present disclosure may be configured such that the controller corrects the correction value based on the result of detection of the environment sensor.

### Advantageous Effects of Disclosure

With the present disclosure, the ideal bias and the adjustment bias obtained through the image-quality adjustment are compared. This makes it possible to determine whether the correction value that is set in the last time is appropriate, which makes it possible to grasp the state of replenishment of toner to the developer. In addition, by reflecting the grasped result, it is possible to replenish the toner at appropriate timing without providing a sensor that detects the amount of toner in the developer.

### BRIEF DESCRIPTION OF THE DRAWINGS

FIG. 1 is a schematic cross-sectional view illustrating the configuration of an image forming device according to a first embodiment of the present disclosure.

FIG. 2 is a perspective view illustrating the internal structure of a developer.

FIG. 3 is a schematic side view illustrating members at or around a photoreceptor drum in an excerpted manner.

FIG. 4 is a diagram illustrating the schematic configuration of the image forming device according to the present embodiment.

FIG. 5 is a characteristic diagram showing a relationship between the photoreceptor drum and a charge potential of a development roller.

FIG. 6 is an expanded explanatory diagram illustrating an expanded intermediate transfer belt and a toner image formed on this belt.

FIG. 7 is an explanatory table showing one example of a replenish table.

FIG. 8 is an explanatory table showing one example of an environment table.

FIG. 9 is an explanatory table showing one example of a charge table.

FIG. 10 is an explanatory table showing one example of a result of correction for a replenishment condition.

FIG. 11 is an explanatory table showing one example of a correction table.

FIG. 12 is an explanatory table showing one example of a result of correction for a replenishment condition in a second embodiment.

FIG. 13 is an explanatory table showing one example of a coefficient table.

### DETAILED DESCRIPTION OF THE INVENTION

### First Embodiment

Below, an image forming device according to the first embodiment of the present disclosure will be described with reference to the drawings.

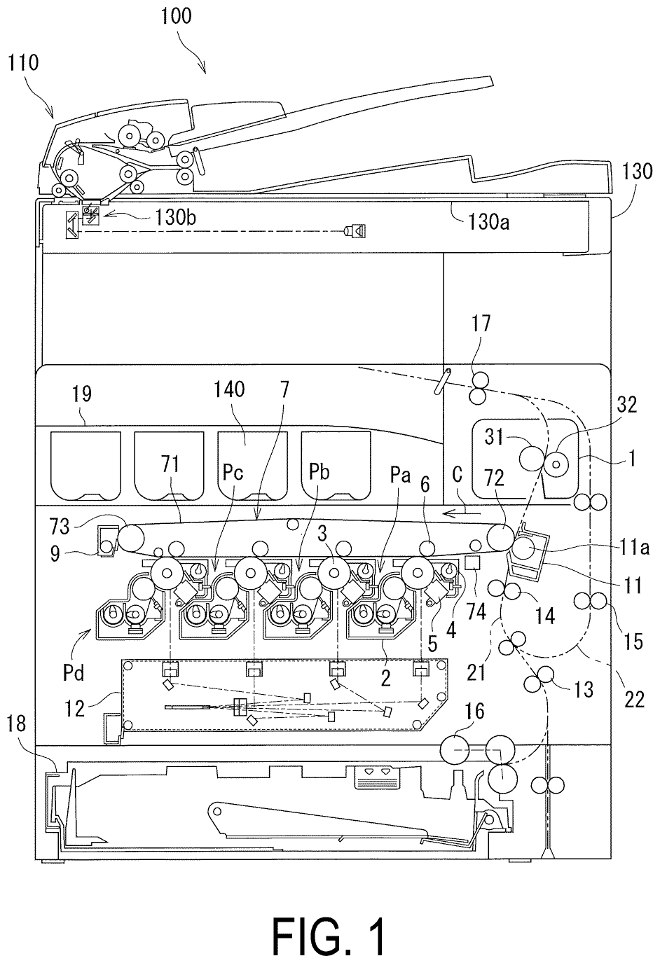

FIG. 1 is a schematic cross-sectional view illustrating the configuration of an image forming device according to a first embodiment of the present disclosure.

The image forming device 100 is a multi-function printer having a copying function, a scanner function, a facsimile function, and a printer function. The image forming device 100 transmits, to the outside, an image of an original document read by an image reading device 130, and forms an image of an original document read by the image reading device 130 or an image received from the outside, on a recording medium such as a sheet in color or in monochrome.

An original-document transport device 110 supported in a freely opening and closing manner is provided at an upper side of the image reading device 130. The original-document transport device 110 sequentially transports one or a plurality of original documents one by one. The image reading device 130 causes a scanning optical system 130b to scan and read an original document placed on a document table 130a, or reads an original document transported by the original-document transport device 110 to generate image data.

The image forming device 100 includes a fixing device 1, a developer 2, a photoreceptor drum 3 (one example of an image carrier), a drum cleaning device 4, a charger 5, an intermediate transfer device 7, a secondary transfer device 11, an exposing unit 12, a paper feeder 18, and the like.

The image forming device 100 handles image data corresponding to a color image comprised of colors of black (K), cyan (C), magenta (M), and yellow (Y), or a monochrome image comprised of a single color (black, for example). The image forming device 100 is provided with four sets of the developer 2, four sets of the photoreceptor drum 3, four sets of the drum cleaning device 4, and four sets of the charger 5 that form four types of toner images. Each of these components is associated with black, cyan, magenta, and yellow, thereby constituting four image stations Pa, Pb, Pc, and Pd, respectively.

The charger 5 uniformly charges the surface of the photoreceptor drum 3 at a predetermined potential. The exposing unit 12 is an optical scanning device, and exposes the surface of the photoreceptor drum 3 to form an electrostatic latent image. The developer 2 develops the electrostatic latent image on the surface of the photoreceptor drum 3 to form a toner image on the surface of the photoreceptor drum 3. The drum cleaning device 4 removes the residual toner on the surface of the photoreceptor drum 3, and collects it. Through the series of operations described above, each color of the toner image is formed on the surface of each of the photoreceptor drums 3.

The intermediate transfer device 7 includes an intermediate transfer roller 6, an endless intermediate transfer belt 71 (one example of an image carrier), an intermediate transfer-driving roller 72, an intermediate transfer-driven roller 73, and a cleaning device 9. Four of the intermediate transfer rollers 6 are provided at an inner side of the intermediate transfer belt 71 to form four types of toner images corresponding to the individual colors. The intermediate transfer rollers 6 transfer the toner images of the individual colors formed on the surfaces of the photoreceptor drums 3 to the intermediate transfer belt 71 that rotates in a rotation direction C.

The intermediate transfer belt 71 is stretched over the intermediate transfer-driving roller 72 and the intermediate transfer-driven roller 73. In the image forming device 100, the toner images of the individual colors formed on the surfaces of the individual photoreceptor drums 3 are sequentially transferred and superimposed on a surface of the intermediate transfer belt 71 to form color toner images. The cleaning device 9 removes and collects waste toner that is not transferred to the sheet and remains on the surface of the intermediate transfer belt 71.

The secondary transfer device 11 nips a sheet transported along a sheet transport path 21 at a transfer nip unit between a secondary transfer roller 11a and the intermediate transfer belt 71 to transport the sheet. When the sheet passes through the transfer nip unit, the toner image on the surface of the intermediate transfer belt 71 is transferred onto the sheet, and the sheet is transported to the fixing device 1.

An image sensor 74 is provided at or around the intermediate transfer belt 71 so as to be opposed to the surface of the intermediate transfer belt 71. The image sensor 74 is disposed between the secondary transfer device 11 and any one of the image stations (image station Pa in FIG. 1) located at the most downstream in the rotation direction C. The image sensor 74 is an optical sensor that emits light to the intermediate transfer belt 71 and receives the reflected light to detect the density of the toner image on the intermediate transfer belt 71. Note that a relationship between the image sensor 74 and the toner image will be described below with reference to FIG. 6.

The fixing device 1 includes a fixing belt 31 and a pressure roller 32 that rotate around the axial line. In the fixing device 1, the sheet to which the toner image is transferred is nipped at a nipper portion between the fixing belt 31 and the pressure roller 32 to be heated and pressurized to fix the toner image on the sheet. Note that, although illustration is not given in FIG. 1, the fixing device 1 may include component members other than the fixing belt 31 and the pressure roller 32.

The paper feeder 18 includes a sheet feeding cassette that stores recording media (sheets) to be used for image formation, and is provided below the exposing unit 12. The sheets are pulled out from the paper feeder 18 by a pickup roller 16, and is transported to the sheet transport path 21. The sheet transported to the sheet transport path 21 passes through the secondary transfer device 11 and the fixing device 1, and is discharged by the discharge roller 17 to a sheet discharge tray 19.

A transporting roller 13, a registration roller 14, and the discharge roller 17 are disposed along the sheet transport path 21. The transporting roller 13 facilitates transporting the sheet. The registration roller 14 transports the sheet at a velocity equal to a process velocity at which an image is formed on the sheet. This registration roller 14 is provided between the paper feeder 18 and the secondary transfer device 11, and adjusts the timing of transporting the sheet, such that the toner image is transferred to the sheet in the secondary transfer device 11. For example, the registration roller 14 is caused to wait (temporarily stop) in a state where the sheet transported from the paper feeder 18 is nipped, and start transporting the sheet at a constant velocity in synchronization with the secondary transfer device 11.

When an image is also formed on a back surface of the sheet in addition to the surface of the sheet, the transport direction of the sheet is changed by the discharge roller 17, and is transported to a reverse transport path 22. In the reverse transport path 22, the sheet is guided to the registration roller 14 in a state of being inverted upside down by a reverse transport roller 15. The image forming device 100 forms an image on the back surface of the sheet guided to the registration roller 14 as with the surface of the sheet, and discharges the sheet to the sheet discharge tray 19.

The image forming device 100 has a configuration in which a cartridge 140 that accommodates toner is mounted, and the toner is supplied from the cartridge 140 to the developer 2 through a transport member (not illustrated). In the present embodiment, four cartridges 140 are mounted so as to correspond to each color to be used, and each of the cartridges 140 is detachably attached to the image forming device 100. Note that the configuration of the cartridge 140 is not limited to the configuration in which only toner is accommodated, and it may be possible to employ a configuration in which a developing agent containing toner and carriers is accommodated. In addition, in a case of employing the cartridge 140 that accommodates toner, the developer 2 is filled with carriers in advance, and toner and the carriers are mixed in the developer 2 to obtain a developing agent.

FIG. 1 illustrates a configuration in which the image forming device 100 transfers a toner image to the sheet through the intermediate transfer belt 71. However, the configuration is not limited to this. It may be possible to employ a configuration in which a toner image is directly transferred to the sheet from the photoreceptor drum 3. That is, FIG. 1 illustrates a configuration of including, as the image carrier, the plurality of photoreceptor drums 3, and the intermediate transfer belt 71 to which a toner image on each of the plurality of photoreceptor drums 3 is transferred. However, the configuration is not limited to this. It may be possible to employ a configuration in which only one photoreceptor drum 3 is provided as the image carrier.

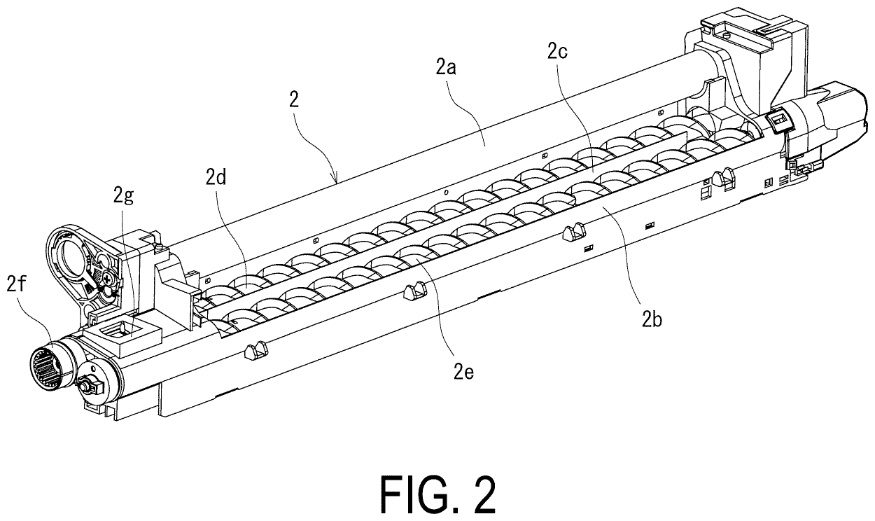

FIG. 2 is a perspective view illustrating the structure of the inside of the developer. Note that FIG. 2 illustrates a state where a portion of the housing of the developer 2 is removed in order to facilitate viewing the inside of the developer 2.

The developer 2 includes a development roller 2a, a first screw 2d, and a second screw 2e, and these components are accommodated in a housing 2b. The housing 2b has a cavity inside thereof, and has a substantially rectangular shape. The housing 2b is partitioned into two regions by a partition wall 2c extending along the longitudinal direction. The partition wall 2c has an opening at a portion corresponding to an end portion in the longitudinal direction, and the developing agent flows between the two regions through this opening. A first screw 2d is provided in one of the regions within the housing 2b, and a second screw 2e is provided in the other region. The first screw 2d and the second screw 2e are disposed so as to be opposed to each other with their axes being parallel to each other. A development gear 2f is coupled to each of the axis of the first screw 2d and the axis of the second screw 2e, and the first screw 2d and the second screw 2e rotate with rotational force from a driving source (not illustrated) transmitted through the development gear 2f.

A reception port 2g for toner is provided at an end portion of the developer 2. The reception port 2g is coupled to the corresponding cartridge 140 and a transport member. In the developer 2, the first screw 2d and the second screw 2e are caused to rotate to circulate, within the housing 2b, the developing agent (toner) supplied from the reception port 2g. In the developer 2, the density (the percentage of toner residing in the developing agent) of toner within the developer varies depending on the amount of replenishment of the toner from the cartridge 140.

The development roller 2a is provided so as to be opposed to the photoreceptor drum 3, and the developing agent is supplied to the photoreceptor drum 3. In the present embodiment, the development roller 2a is disposed at an upper side of the first screw 2d. However, the configuration is not limited to this. It is only necessary that the development roller 2a is provided in the developer 2 so as to face a portion where the developing agent is supplied to the outside.

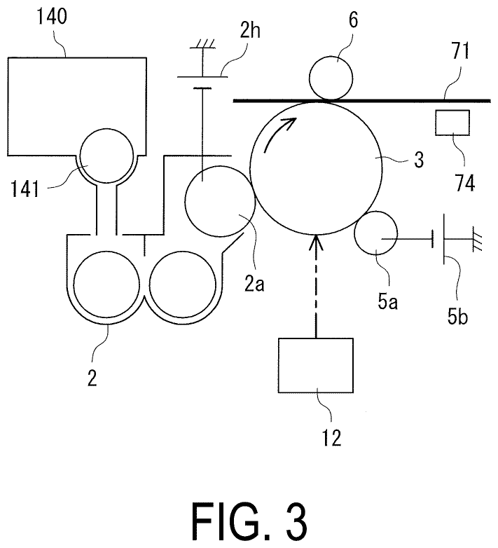

FIG. 3 is a schematic side diagram illustrating members at or around the photoreceptor drum in an excerpted manner.

FIG. 3 illustrates one photoreceptor drum 3 and members in a portion associated with the photoreceptor drum 3 in an excerpted manner. Specifically, the charger 5 includes a charging roller 5a coming into contact with the photoreceptor drum 3, and the charging roller 5a is supplied with a bias from a charging power supply 5b that is coupled. In addition, the development roller 2a is in contact with the photoreceptor drum 3, and is supplied with a bias from a development-power supplier 2h that is coupled. Furthermore, a replenisher 141 that replenishes the developer 2 with toner is coupled to the cartridge 140.

The replenisher 141 is comprised of a screw that transports toner, a gear that transmits power to the screw, a motor coupled to the gear, the transport member described above, and the like, and the amount of replenishment of the toner to the developer 2 is determined according to the amount of operation of the replenisher 141. In the present embodiment, a replenishment period in which the replenisher 141 is operated is set as a replenishment condition concerning toner to the developer 2. However, the condition is not limited to this. It is only necessary that a matter concerning the amount of replenishment of the toner is set in the replenishment condition.

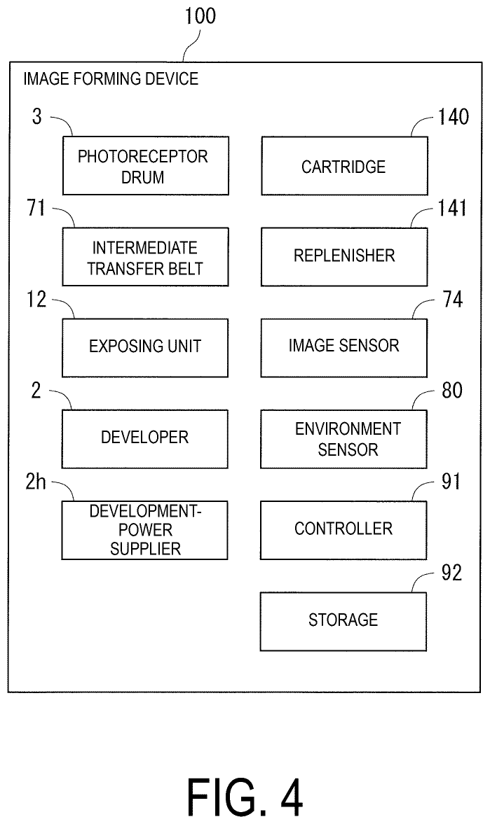

FIG. 4 is a diagram illustrating the schematic configuration of the image forming device according to the present embodiment. Note that, in FIG. 4, a portion of the image forming device 100 is extracted and illustrated, and other members that are not illustrated in FIG. 4 may be provided on an as-necessary basis.

The image forming device 100 includes the developer 2, the development-power supplier 2h, the photoreceptor drum 3, the exposing unit 12, the intermediate transfer belt 71, the image sensor 74, the cartridge 140, and the replenisher 141 that have been described above, and also includes an environment sensor 80, a controller 91, and a storage 92. The environment sensor 80 detects a temperature and humidity of the environment where the image forming device 100 is disposed. The controller 91 is a CPU mounted on the image forming device 100, and controls operations of the image forming device 100. In addition, the controller performs image-quality adjustment described below, for example. The storage 92 holds various types of information concerning operations of the image forming device 100.

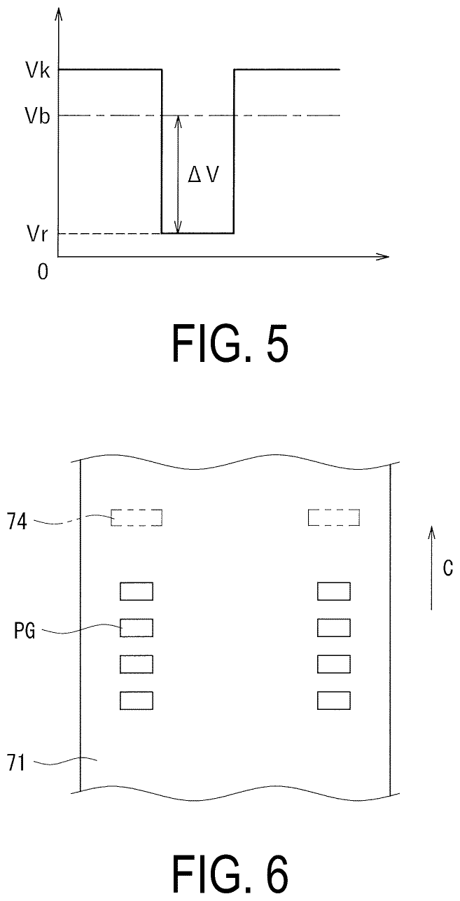

Next, a relationship between the charge potential of the surface of the photoreceptor drum 3 and the amount of charge of toner will be described with reference to FIG. 5.

FIG. 5 is a characteristic diagram showing a relationship between a charge potential of the photoreceptor drum and a charge potential of the development roller.

As described above, the image forming device 100 performs processes of charging at the photoreceptor drum 3, exposure, and development to form a toner image, and the potential (bias) in each of the processes influences the image quality (density) of a toner image. Specifically, the photoreceptor drum 3 is charged at a predetermined photoreceptor bias Vk with a bias applied to the charging roller 5a. In addition, the exposing unit 12 exposes a region of a portion of the surface of the photoreceptor drum 3 to which toner is attached, to change it to an exposure bias Vr close to 0 V. The development roller 2a is charged at a developing bias Vb having an absolute value smaller than that of the photoreceptor bias Vk. With a difference (toner potential difference ΔV) between the developing bias Vb and the exposure bias Vr, toner supplied to the development roller 2a is drawn to the surface of the photoreceptor drum 3. That is, depending on the toner potential difference ΔV, the amount of attachment of the toner on the surface of the photoreceptor drum 3 varies, and the density of the toner image also varies. Note that, in one example illustrated in FIG. 5, the photoreceptor bias Vk is set at −450 V, the developing bias Vb is set at −400 V, and the exposure bias Vr is set to approximately −100 to −50 V.

Incidentally, the density of the toner image varies not only depending on the toner potential difference ΔV but also depending on the density of toner at the developer 2 or temperatures and humidity in the environment where the image forming device 100 is disposed or the state of the surface of the development roller 2a or the like. For this reason, the image forming device 100 forms a toner image on the image carrier, and performs image-quality adjustment that changes the developing bias Vb based on a result of detection of the density of this toner image by the image sensor 74. Through this image-quality adjustment, adjustment is performed so as to obtain the desired density of the toner image.

Next, the toner image (patch image) formed at the time of image-quality adjustment will be described with reference to FIG. 6.

FIG. 6 is an expanded explanatory diagram illustrating an expanded intermediate transfer belt and a toner image formed on this belt.

FIG. 6 illustrates a portion of the expanded intermediate transfer belt 71 and schematically illustrates a positional relationship of the toner image (patch image PG) and the image sensor 74 with respect to the intermediate transfer belt 71. In the present embodiment, patch images PG formed on four photoreceptor drums 3 are each transferred to the intermediate transfer belt 71 that is in a state of circulating and moving in a rotation direction C (upward direction in FIG. 6). There is no limitation as to the location where the patch images PG are formed, and it is only necessary to form them at locations that can be detected by the image sensor 74 when the intermediate transfer belt 71 circulates and moves.

At the time of image-quality adjustment, the developing bias is changed stepwise, and a plurality of patch images PG are formed on the corresponding photoreceptor drums 3, and are transferred to the intermediate transfer belt 71. Then, the densities of the plurality of patch images PG are detected by the image sensor 74. Based on the thus obtained result, the adjustment bias is calculated as a value of the developing bias from which a desired density can be obtained. In the configuration in which a plurality of image stations are provided as in the present embodiment, it is preferable to calculate the adjustment bias at each of the image stations.

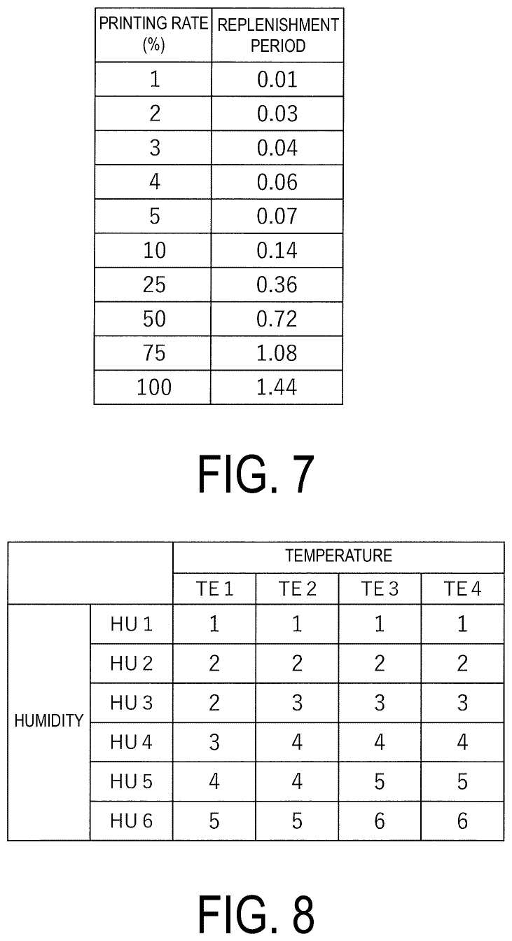

As described above, the image forming device 100 has a configuration in which the developer 2 is replenished with toner at any time, and the replenishment condition corresponding to the amount of consumption of the toner is set. Next, a replenish table concerning the replenishment condition will be described with reference to FIG. 7.

FIG. 7 is an explanatory table showing one example of a replenish table.

The replenish table shown in FIG. 7 is held in the storage 92. A printing rate corresponding to the amount of consumption of the toner and a replenishment period serving as the replenishment condition are associated in the replenish table. The printing rate is a value calculated based on image data, and corresponds to a percentage of portions colored by the toner from among one sheet. That is, as the printing rate increases, the amount of consumption of the toner increases. Note that, when image formation is performed consecutively to a plurality of sheets, the printing rate may be collectively calculated for these sheets at one time. The replenishment period indicates a period of time in which the replenisher 141 is operated. As the replenishment period increases, the amount of replenishment of the toner to the developer 2 increases. It is only necessary that the printing rate and the replenishment period have an appropriate relationship that depends on the configuration of the image forming device 100, and the amount of replenishment is set so as to make up for the amount of consumption of the toner at the developer 2.

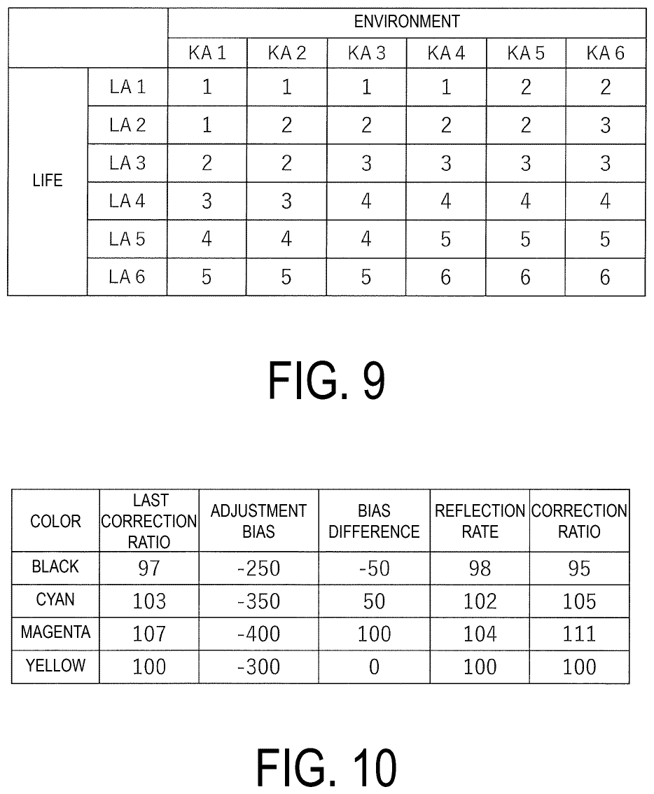

As described above, temperatures and humidity in the environment where the image forming device 100 is disposed and the operating status of the development roller 2a influence the density of a toner image. Thus, the present embodiment collects information concerning these items to reflect it in the operation of the image forming device 100. Next, tables concerning temperatures and humidity as well as the state of the surface of the development roller 2a will be described with reference to FIGS. 8 and 9.

FIG. 8 is an explanatory table showing one example of an environment table.

The environment table illustrated in FIG. 8 is held in the storage 92, and is a table relating to temperatures and humidity. In the environment table, a plurality of ranges are provided for temperatures and humidity that the environment sensor 80 detects, and are set so as not to overlap with each other. Specifically, four ranges (from a first temperature range TE1 to a fourth temperature range TE4) are provided for temperatures, and temperatures increase in the order of the first temperature range TE1, the second temperature range TE2, the third temperature range TE3, and the fourth temperature range TE4. In addition, six ranges (from a first humidity range HU1 to a sixth humidity range HU6) are provided for humidity, and humidity increases in the order of the first humidity range HU1, the second humidity range HU2, . . . , and the sixth humidity range HU6. Furthermore, environment levels corresponding to temperatures and humidity are assigned in the environment table, and values of “1” to “6” are used as the environment levels. For the environment levels in the environment table, “1” is assigned when temperature and humidity are low, and environment levels having higher values are assigned as temperature and humidity increase. That is, the low environment level indicates a low-temperature and low-humidity environment, and the high environment level indicates a high-temperature and high-humidity environment.

FIG. 8 illustrates a case where four ranges concerning temperature are provided, six ranges concerning humidity are provided, and values of “1” to “6” are used as the environment level. However, settings are not limited to these. The number of ranges concerning temperature and humidity may be changed, and the numerical values used in the environment level may be changed. That is, temperature and humidity may be divided into more fine ranges, and the values used in the environment level may be increased.

FIG. 9 is an explanatory table showing one example of a charge table.

The charge table illustrated in FIG. 9 is held in the storage 92, and is a table concerning the environment level and the operating status of the development roller 2a. In the present embodiment, the accumulated travel period is recorded as the operating status of the development roller 2a.

The travel period of the development roller 2a corresponds to the distance (the number of rotations) in which the development roller 2a rotates when a toner image is formed. As the travel period of the development roller 2a increases, the toner is difficult to be charged, and the amount of charge reduces. The amount of charge of the toner influences the amount of consumption during image formation. In addition, temperatures and humidity also influence the amount of charge of the toner. In a low-temperature and low-humidity environment, the amount of charge increases. In a high-temperature and high-humidity environment, the amount of charge reduces.

In the charge table, six ranges (from a first life range LA1 to a sixth life range LA6) are provided for the travel period of the development roller 2a, and are set so as not to overlap with each other. The travel period increases in the order of the first life range LA1, the second life range LA2, . . . , and the sixth life range LA6. In addition, charge levels corresponding to the environment levels and the travel periods of the development roller 2a are assigned in the charge table, and values of “1” to “6” are used as the charge levels. For the charge levels in the charge table, “1” is assigned when the environment level and the travel period of the development roller 2a are low, and charge levels having higher values are assigned as the environment level and the travel period of the development roller 2a increase. That is, the low charge level indicates a situation where the amount of charge is high, and the high charge level indicates the situation where the amount of charge is low.

The image forming device 100 looks up the charge table illustrated in FIG. 9 to calculate an ideal bias that is an appropriate developing bias under the current situation. In the present embodiment, a reference value is set in advance for the developing bias, and a charge correction value corresponding to the charge level is added to the reference value to calculate the ideal bias. The ideal bias may be calculated at any timing, and for example, is calculated at the timing of image-quality adjustment to be stored in the storage 92.

For example, when the reference value is set to −300 V and the charge correction value in a case where the charge level is “1” is set to −30 V, the ideal bias is −330 V. That is, in a situation where the amount of charge is high, the ideal bias is corrected so as to reduce the amount of charge. In addition, when the reference value is set to −300 V and the charge correction value in a case where the charge level is “6” is set to 65 V, the ideal bias is −235 V, and the ideal bias is corrected so as to increase the amount of charge.

Note that, for the charge table illustrated in FIG. 9, the travel period of the development roller 2a may be divided into more fine ranges to increase the numerical value used for the charge levels, as with the environment table illustrated in FIG. 8.

The image forming device 100 corrects the replenishment condition concerning toner based on a result of the image-quality adjustment. Next, the relationship between the result of the image-quality adjustment and the correction of the replenishment condition will be described with reference to FIG. 10.

FIG. 10 is an explanatory table showing one example of a result of correction for the replenishment condition.

FIG. 10 shows one example of the result of correction for the replenishment condition, and is a table summarizing the results of correction for each of the four image stations. Note that by using corresponding colors, the four image stations Pa, Pb, Pc, and Pd may be simply referred to as black, cyan, magenta, and yellow, respectively, for the purpose of explanation below.

In the table shown in FIG. 10, items of “last correction ratio,” “adjustment bias,” “bias difference,” “reflection rate,” and “correction ratio” are provided for each of black, cyan, magenta, and yellow. In the present embodiment, the replenishment condition is corrected in conjunction with the image-quality adjustment, and values of individual items are determined. The image-quality adjustment is performed at predetermined intervals, and the storage 92 holds the values (in particular, correction ratios) of each of the items. Below, for the purpose of clarifying timing at which the image-quality adjustment is performed, the image-quality adjustment may be referred to as the last image-quality adjustment, current image-quality adjustment, and next image-quality adjustment to be distinguished from each other.

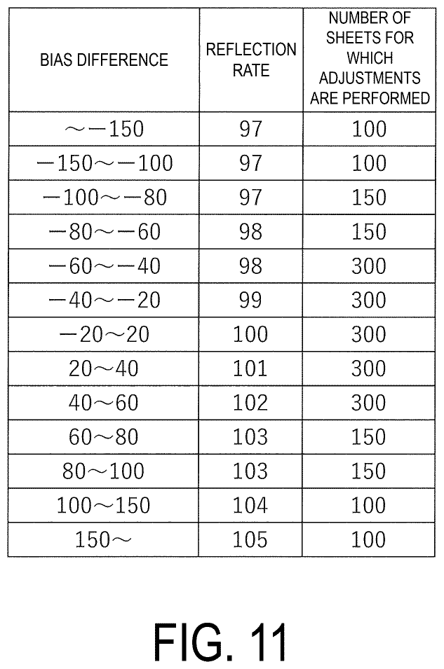

The “last correction ratio” corresponds to a correction ratio (Hz) calculated during the image-quality adjustment at the last time, and the correction ratio is calculated by a computational expression A that will be described below. The “adjustment bias” corresponds to the adjustment bias calculated at the time of the current image-quality adjustment. The “bias difference” corresponds to a bias difference between the ideal bias and the adjustment bias calculated at the time of the current image-quality adjustment, and specifically, is a value obtained by subtracting the adjustment bias from the ideal bias. The “reflection rate” corresponds to the reflection rate (a) determined by looking up the correction table shown in FIG. 11 that will be described below, and the reflection rate is a value corresponding to the bias difference. The “correction ratio” corresponds to the correction ratio (H) calculated by using the computational expression A “H=Hz×α/100” at the time of the current image-quality adjustment. In the computational expression A described above, “H” represents the correction ratio, “Hz” represents the last correction ratio, and “α” represents the reflection rate.

FIG. 11 is an explanatory table showing one example of the correction table.

The correction table shown in FIG. 11 is held in the storage 92, and is a table concerning the bias difference, the reflection rate, and the number of sheets for which adjustment is performed. In the correction table, a plurality of ranges are provided for the bias difference, and are set so as not to overlap with each other, and the reflection rate and the number of sheets for which adjustment is performed are set for each of the ranges. In the correction table, “100” is set as the reflection rate when the bias difference is “0 (−20 to 20)”, and the reflection rates are set such that the degree of increase or decrease from “100” increases as the absolute value of the bias difference increases. By providing the correction table to set the reflection rate in advance in this manner, it is possible to simplify the process of correction.

In the present embodiment, the number of sheets for which image formation is performed is applied as the interval at which the image-quality adjustment is performed. Image-quality adjustment is performed after images are formed on sheets of which number is set as the number of sheets for which adjustment is performed. In the correction table, the number of sheets for which adjustment is performed is set to be larger when the absolute value of the bias difference is small, and the number of sheets for which adjustment is performed reduces as the absolute value of the bias difference increases.

The image forming device 100 corrects the replenishment condition concerning toner based on a result of the image-quality adjustment, and the bias difference is influenced by the density of toner at the developer 2. That is, when the absolute value of the bias difference is large, it is indicated that the density of toner at the developer 2 deviates from a desired value. Thus, by changing the interval of the image-quality adjustment, even when the amount of replenishment of the toner deviates more than expected, it is possible to review the amount of replenishment of the toner before the amount further largely changes, and keep the appropriate amount of toner at the developer 2.

In addition, when the number of sheets for which adjustment is performed differs in the four image stations, it is preferable to select the minimum number of sheets for which adjustment is performed. The controller 91 changes the interval for the next image-quality adjustment based on the bias difference having the maximum value. By collectively performing the image-quality adjustment in accordance with the image station of which deviation is the maximum, it is possible to appropriately correct the amount of replenishment while aligning the timing of the image-quality adjustment.

FIG. 11 shows the correction table in which the bias difference, the incorporation rate, and the number of sheets for which adjustment is performed are associated. However, the configuration is not limited to this. It may be possible to provide a plurality of correction tables in which the reflection rate and the number of sheets for which adjustments are performed are separately associated with the bias difference.

The image forming device applies the correction ratio determined through the method described above as the correction value used until the next image-quality adjustment to correct the replenishment condition concerning toner. For example, based on the correction ratio, it is only necessary to increase or decrease the replenishment period determined based on FIG. 7. In this manner, by comparing the ideal bias and the adjustment bias obtained through the image-quality adjustment, it is possible to determine whether the correction value set in the previous time is appropriate, and it is possible to grasp the state of replenishment of toner to the developer 2. In addition, by reflecting the grasped result, it is possible to replenish toner at appropriate timing without providing a sensor that detects the amount of toner at the developer 2.

With reference to the result of correction shown in FIG. 10, for example, in a case of cyan, the “last correction ratio” is “103,” the “bias difference” is “50,” and the adjustment bias is higher than the ideal bias. Thus, it is expected that the amount of replenishment of the toner is small. In addition, the “correction ratio” is “105,” and correction is made so as to increase the amount of replenishment of the toner from the last time.

### Second Embodiment

Next, an image forming device according to the second embodiment of the disclosure will be described with reference to the drawings. Note that the image forming device according to the second embodiment has a configuration substantially similar to that of the first embodiment illustrated in FIGS. 1 to 11. Thus, similar reference characters are attached, and explanation thereof or the drawings will not be repeated.

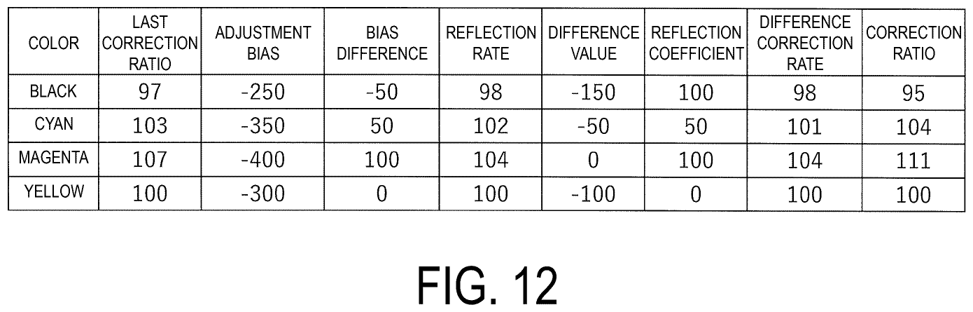

FIG. 12 is an explanatory table showing one example of a result of correction for a replenishment condition in the second embodiment.

The second embodiment differs from the first embodiment in that the common bias that is common to a plurality of developers 2 is used as the developing bias, and the development-power supplier 2h supplies it. That is, one development-power supplier 2h is coupled to four developers 2 in the four image stations in a shared manner. In addition, the controller 91 corrects the replenishment condition based on a difference between the common bias and the adjustment bias. Next, the correcting method in the present embodiment will be described with reference to one example of the result of correction illustrated in FIG. 12.

FIG. 12 shows one example of a result of correction for the replenishment condition in the image forming device according to the second embodiment of the disclosure, and is a table that summarizes results of correction for each of four image stations.

In the table shown in FIG. 12, items of “last correction ratio,” “adjustment bias,” “bias difference,” “reflection rate,” and “correction ratio” are provided for each of black, cyan, magenta, and yellow as in the table shown in FIG. 10, and items of “difference value,” “reflection coefficient,” and “difference correction value” are added. Note that, in the table shown in FIG. 12, the items of “last correction ratio,” “adjustment bias,” “bias difference,” and “reflection rate” are the same as those in the table shown in FIG. 10, and hence, explanation thereof will not be repeated.

The “difference value” corresponds to a difference value that is a difference between the common bias and the ideal bias, and specifically, is a value obtained by subtracting the adjustment bias from the common bias. In the present embodiment, for the common bias, the value closest to the photoreceptor bias Vk is selected from among adjustment biases. Specifically, in one example shown in FIG. 12, −400 V in magenta is selected.

The “reflection coefficient” corresponds to a reflection coefficient (B) determined by looking up a coefficient table shown in FIG. 12 that will be described below, and the reflection coefficient is set at a value corresponding to the difference value. The “difference correction value” corresponds to a difference correction value (γ) calculated by using a computational expression B “γ=(α−100)×β/100+100.” In the computational expression B, β represents the reflection coefficient, and γ represents the difference correction value.

In the present embodiment, the correction ratio is calculated by using a computational expression C “H=Hz×γ/100.” In the computational expression C, the reflection rate (α) in the computational expression A is replaced with the difference correction value (γ), and the difference correction value is calculated with the reflection rate being corrected using the reflection coefficient.

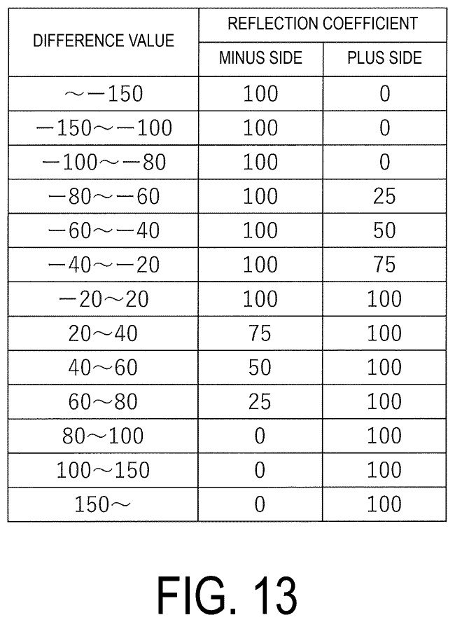

FIG. 13 is an explanatory table showing one example of the coefficient table.

The coefficient table illustrated in FIG. 13 is held in the storage 92, and is a table concerning the difference value and the reflection coefficient. In the coefficient table, a plurality of ranges are provided for the difference value, and are set so as not to overlap with each other, and the reflection coefficients are set for each of the ranges. The coefficient table is set such that different columns (values) are supposed to be looked up depending on whether the value of the bias difference is a plus (positive) value or a minus (negative) value.

For example, it is assumed that the difference value is “50 (40 to 60).” When the bias difference is a minus value, the reflection coefficient is set to “50,” and when the bias difference is a plus value, the reflection coefficient is set to “100.” That is, when the common bias is higher than the adjustment bias, development is performed so as to be darker than when the value of the adjustment bias is applied to the developing bias. Thus, it is not necessary to increase the amount of replenishment of the toner, and it may be possible to make adjustment so as to reduce it. In addition, when the common bias is lower than the adjustment bias, development is performed so as to be lighter than when the value of the adjustment bias is applied to the developing bias. Thus, it is not necessary to reduce the amount of replenishment of the toner, and it may be possible to make adjustment so as to increase it. In this manner, when the development-power supplier 2h is shared, it is possible to make correction to an appropriate value by considering the difference from the common bias.

With reference to the result of correction shown in FIG. 12, for example, in a case of cyan, the “correction ratio” is “104,” and correction is made such that the correction value is smaller than the result of correction shown in FIG. 10.

In addition, as for correction of the replenishment condition, it may be possible to reflect a result of detection of the environment sensor in addition to the correction ratio described above. Specifically, at the time of correction, the environment table and the charge table described above are looked up to determine the environment level and the charge level. In addition, it is only necessary that a correction coefficient for the environment level and the charge level is set in advance to increase or reduce the replenishment period based on the coefficient. In this manner, by considering the environment where the image forming device 100 is disposed, it is possible to make correction to a more appropriate correction value.

Note that the embodiments disclosed herein are given as an example in all respects, and are not the basis for a limited interpretation. Thus, the technical scope of the disclosure is not to be construed only by the embodiment described above, and is defined based on the description of the claims. In addition, meanings equivalent to the range of the claims and all changes made within the range should be included.

### REFERENCE SIGNS LIST

2 Developer
2a Development roller
2h Development-power supplier
3 Photoreceptor drum
12 Exposing unit
71 Intermediate transfer belt
74 Image sensor
80 Environment sensor
91 Controller
92 Storage
100 Image forming device
140 Cartridge
141 Replenisher

1. An image forming device comprising:
an image carrier including a surface charged at a predetermined potential;
a developer that forms a toner image on the image carrier;
a development-power supplier that supplies the developer with a developing bias;
an image sensor that detects a density of a toner image formed by the developer;
an environment sensor that detects a temperature and humidity;
a replenisher that replenishes the developer with toner; and
a controller that causes image-quality adjustment that changes the developing bias to be performed based on a result of detection of the image sensor, wherein
the controller includes a storage that holds a replenishment condition, a correction value for the replenishment condition set in the image-quality adjustment, and an ideal bias set based on a result of detection of the environment sensor, the replenishment condition being a condition in which timing at which the replenisher replenishes the toner is set, and
the controller corrects a correction value used until next image-quality adjustment based on a bias difference that is a difference between the ideal bias and an adjustment bias calculated at a time of the image-quality adjustment, and a last correction value set in image-quality adjustment at last time.

2. The image forming device according to claim 1, wherein
the storage holds a correction table in which a reflection rate corresponding to the bias difference is set, and
at a time of the image-quality adjustment, the controller corrects the correction value by looking up the reflection rate in the correction table.

3. The image forming device according to claim 1, wherein the controller changes an interval for next image-quality adjustment based on the bias difference.

4. The image forming device according to claim 1, wherein
the image carrier includes a plurality of photoreceptor drums and an intermediate transfer belt to which a toner image on each of the plurality of photoreceptor drums is transferred, and
a plurality of the developers and the replenishers are provided so as to correspond to the plurality of photoreceptor drums.

5. The image forming device according to claim 4, wherein
during the image-quality adjustment, the bias difference is calculated for each of the plurality of the developers, and
the controller changes an interval for next image-quality adjustment based on the bias difference having a maximum value.

6. The image forming device according to claim 4, wherein
the development-power supplier supplies a common bias that is common to the plurality of the developers as the developing bias, and
the controller corrects the correction value based on a difference between the common bias and the adjustment bias.

7. The image forming device according to claim 1, wherein
the controller corrects the correction value based on the result of detection of the environment sensor.
